(19) United States
(12) Patent Application Publication
(10) Pub. No.: US 2024/0424741 A1
(43) Pub. Date: Dec. 26, 2024

(54) CLEANING APPARATUS

(71) Applicant: SEIKO EPSON CORPORATION, TOKYO (JP)

(72) Inventors: Tomoki ABE, Matsumoto-shi (JP); Hirokazu SEKINO, Chino-shi (JP); Kaname NAGATANI, MATSUMOTO-SHI (JP)

(21) Appl. No.: 18/754,668

(22) Filed: Jun. 26, 2024

(30) Foreign Application Priority Data
Jun. 26, 2023 (JP) 2023-104357

(51) Int. Cl. B29C 64/40; B08B 3/02; B08B 3/10; B08B 13/00; B29C 64/30; B33Y 40/20

(52) U.S. Cl. CPC B29C 64/40; B08B 3/02; B08B 3/10; B08B 13/00; B29C 64/30; B33Y 40/20; B08B 2203/007; B08B 2203/02

(57) ABSTRACT

A cleaning apparatus 1 includes a nozzle 11 configured to spray liquid 3 in continuous flow 3a and turn the continuous flow 3a into droplets 3b and a pump 21 configured to supply the liquid 3 to the nozzle 11, wherein the cleaning apparatus 1 is configured to remove a support material 4b from a three dimensional molded object 4a in a cleaning target 4 by causing the liquid 3 from the nozzle 11 to collide with the cleaning target 4 in a droplet 3b form.

The present application is based on, and claims priority from JP Application Serial Number 2023-104357, filed Jun. 26, 2023, the disclosure of which is hereby incorporated by reference herein in its entirety.

### BACKGROUND

### 1. Technical Field

The present disclosure relates to a cleaning apparatus.

### 2. Related Art

In a related art, a three dimensional molding device for molding a three dimensional molded object is used. Among these devices, there is a three dimensional molding device that molds a three dimensional molded object while temporarily supporting the three dimensional molded object with a support material. In the three dimensional molded object molded by the three dimensional molding device having such a configuration, the support material is removed after the molding. Here, it is described in JP-T-2018-509501 that a specific water-soluble polymer compound is used in order to facilitate removal of a support material formulation. JP-A-2011-5666 discloses a method for removing a support material adhered to a molded object by water-jet-water.

However, a removal effect of a support material is weak only by spraying water-jet-water to the support material adhered to a three dimensional molded object, and it is necessary to increase the spray water amount in order to effectively remove the support material. On the other hand, when the spray water amount is increased, a three dimensional molded object is easily damaged.

### SUMMARY

A cleaning apparatus of the present disclosure for solving the above-described problem includes a nozzle configured to spray liquid in a continuous flow and change the continuous flow into droplets and a pump configured to supply the liquid to the nozzle, wherein the cleaning apparatus is configured to remove a support material from a three dimensional molded object in a cleaning target by causing the liquid from the nozzle to collide with the cleaning target in a droplet form.

A cleaning apparatus of the present disclosure for solving the above-described problem includes a nozzle configured to spray liquid in a continuous flow and change the continuous flow into droplets and a pump configured to supply the liquid to the nozzle, wherein the cleaning apparatus is configured to remove an adhering substance from a cleaning target by spraying the liquid from the nozzle to the cleaning target and causing the liquid to collide with the cleaning target in a droplet form.

### BRIEF DESCRIPTION OF THE DRAWINGS

FIG. 1 is a schematic diagram showing a cleaning apparatus according to a first embodiment.

FIG. 2 is a flowchart showing an example of using the cleaning apparatus of FIG. 1.

FIG. 3 is a schematic diagram showing a cleaning apparatus according to a second embodiment.

FIG. 4 is a schematic diagram showing a cleaning apparatus according to a third embodiment.

FIG. 5 is a schematic diagram showing a cleaning apparatus according to a fourth embodiment, and is a diagram showing an example of removing UV ink from a resin plate.

FIG. 6 is a schematic diagram showing a cleaning apparatus according to a fourth embodiment, and is a diagram showing an example of removing dirt from a wall.

FIG. 7 is a schematic diagram showing a cleaning apparatus according to a fourth embodiment, and is a diagram showing an example of removing oil adhered to a cut product from the cut product.

### DESCRIPTION OF EMBODIMENTS

First, the present disclosure will be schematically described.

A cleaning apparatus according to a first aspect of the present disclosure for solving the above-described problem includes a nozzle configured to spray liquid in a continuous flow and change the continuous flow into droplets and a pump configured to supply the liquid to the nozzle, wherein the cleaning apparatus is configured to remove a support material from a three dimensional molded object in a cleaning target by spraying the liquid from the nozzle to the cleaning target, which was molded by a three dimensional molding device that molds the three dimensional molded object while supporting the three dimensional molded object with the support material, and by causing the liquid to collide with the cleaning target in a droplet form.

According to the aspect, the support material is removed from the three dimensional molded object by causing liquid to collide with the cleaning target in a droplet form using the nozzle that sprays liquid in continuous flow and that changes the continuous flow into droplets. Since the liquid is sprayed from the nozzle in a continuous flow and the continuous flow is changed into droplets to collide with the cleaning target in a droplet form, the cleaning effect of the liquid on the cleaning target is dramatically improved as compared with a configuration in which water-jet-water is simply sprayed from the nozzle. Therefore, it is possible to effectively remove the support material from the three dimensional molded object while suppressing damage to the three dimensional molded object when removing the support material from the three dimensional molded object.

A cleaning apparatus according to a second aspect of the present disclosure is an aspect according to the first aspect, and the cleaning apparatus further includes a spray pressure adjustment section configured to adjust a spray pressure of the liquid from the nozzle in accordance with a type of the support material.

According to the aspect, it is possible to adjust a spray pressure of the liquid from the nozzle according to the type of the support material. Therefore, it is possible to effectively remove the support material from the three dimensional molded object in accordance with the type of the support material.

A cleaning apparatus according to a third aspect of the present disclosure is an aspect according to the second aspect, and multiple types can be used as the support material and the cleaning apparatus further includes a memory section configured to store a correspondence relationship between a type of the support material and a spray pressure of the liquid.

According to the aspect, the cleaning apparatus includes the memory section configured to store a correspondence relationship between type of support material and spray pressure of the liquid. Therefore, it is possible to suitably adjust the spray pressure of the liquid from the nozzle automatically in accordance with the type of the support material to be used.

A cleaning apparatus according to a fourth aspect of the present disclosure is an aspect according to any one of the first to third aspects, and the nozzle is configured to change a nozzle diameter.

According to the aspect, the nozzle diameter can be changed. Therefore, for example, it is possible to spray liquid from a nozzle having a desirable nozzle diameter in accordance with the type of the support material.

A cleaning apparatus according to a fifth aspect of the present disclosure is an aspect according to any one of the first to third aspects, and the cleaning apparatus further includes a heater configured to heat the liquid.

According to the aspect, the cleaning apparatus includes the heater configured to heat the liquid. Therefore, by heating the liquid, the performance of removing the support material from the three dimensional molded object can be improved.

A cleaning apparatus according to a sixth aspect of the present disclosure is an aspect according to the fifth aspect, and the cleaning apparatus further includes a temperature controller configured to control the heater in accordance with a type of the support material.

According to the aspect, it is possible to control the heater in accordance with the type of the support material. Therefore, it is possible to improve the performance of automatically removing the support material from the three dimensional molded object in accordance with the type of the support material.

A cleaning apparatus according to a seventh aspect of the present disclosure is an aspect according to any one of the first to third aspects, and the cleaning apparatus further includes a main body to which the nozzle is connected and which includes a flow path through which the liquid flows inside.

According to the aspect, the cleaning apparatus includes a main body to which the nozzle is connected and which includes a flow path through which the liquid flows inside. Therefore, for example, a user can grip the main body and easily cause the droplets to collide with a desired location of the cleaning target.

A cleaning apparatus according to an eighth aspect of the present disclosure is an aspect according to any one of the first to third aspects, and the cleaning apparatus further includes a holder configured to hold an apparatus different from the nozzle for removing the support material.

According to the aspect, the cleaning apparatus includes a holder configured to hold an apparatus different from the nozzle for removing the support material. Therefore, since an apparatus different from the nozzle for removing the support material can be used, it is possible to improve the performance of removing the support material from the three dimensional molded object, and it is possible to eliminate the need to separately prepare a constituent member for holding the apparatus.

A cleaning apparatus according to a ninth aspect of the present disclosure is an aspect according to any one of the first to third aspects, and the cleaning apparatus further includes a housing inside which the nozzle is used.

According to the aspect, the cleaning apparatus includes a housing in which the nozzle is used. Therefore, it is possible to suppress liquid or the removed support material from being scattered to the outside of the cleaning apparatus.

A cleaning apparatus according to a tenth aspect of the present disclosure is an aspect according to the ninth aspect, and the housing includes a reservoir that accumulates the liquid that was sprayed from the nozzle.

According to the aspect, the housing includes a reservoir that accumulates the liquid that was sprayed from the nozzle. Therefore, it is possible to efficiently collect the liquid that was sprayed from the nozzles.

A cleaning apparatus according to an eleventh aspect of the present disclosure is an aspect according to the tenth aspect, and the cleaning apparatus further includes a circulation mechanism for spraying the liquid accumulated in the reservoir from the nozzle again.

According to the aspect, the cleaning apparatus includes a circulation mechanism for spraying the liquid accumulated in the reservoir from the nozzle again. Therefore, it is possible to reuse liquid which was sprayed once from the nozzle and then collected.

A cleaning apparatus according to a twelfth aspect of the present disclosure is an aspect according to the ninth aspect, and the housing includes a temperature adjustment section configured to adjust a temperature in the housing.

According to the aspect, the housing includes a temperature adjustment section configured to adjust the temperature in the housing. Therefore, for example, the performance of removing the support material from the three dimensional molded object can be improved.

A cleaning apparatus according to a thirteenth aspect of the present disclosure includes a nozzle configured to spray liquid in a continuous flow and change the continuous flow into droplets and a pump configured to supply the liquid to the nozzle, wherein the cleaning apparatus is configured to remove an adhering substance from a cleaning target by spraying the liquid from the nozzle to the cleaning target and causing the liquid to collide with the cleaning target in a droplet form.

According to the aspect, the adhering substance is removed from the cleaning target by causing liquid to collide with the cleaning target in a droplet form using the nozzle that sprays liquid in continuous flow and changes the continuous flow into droplets. Since the liquid is sprayed from the nozzle in a continuous flow and the continuous flow is changed into droplets to collide with the cleaning target in a droplet form, the cleaning effect of the liquid on the cleaning target is dramatically improved as compared with a configuration in which water-jet-water is simply sprayed from the nozzle. Therefore, it is possible to effectively remove the adhering substance from the cleaning target while suppressing damage to the cleaning target when removing the adhering substance from the cleaning target.

### First Embodiment

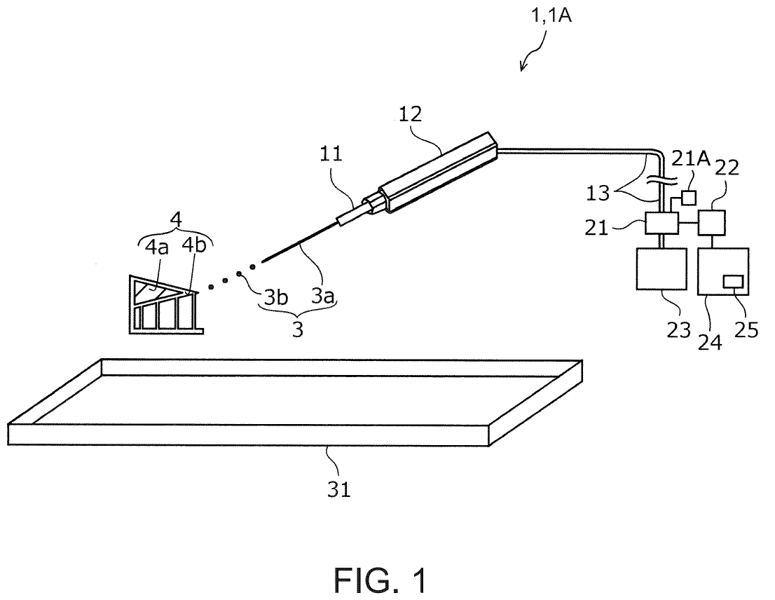

Hereinafter, embodiments of the present disclosure will be described with reference to the accompanying drawings. A cleaning apparatus 1 of the present disclosure is configured to remove an adhering substance 4b from an object 4a of a cleaning target 4 by spraying liquid 3 in a continuous flow 3a and turning the continuous flow 3a into droplets 3b, and causing the liquid 3 to collide with the cleaning target 4 in a state of the droplets 3b. First, an outline of a cleaning apparatus 1A according to a first embodiment, which is an example of the cleaning apparatus 1 of the present disclosure, will be described with reference to FIG. 1.

A cleaning apparatus 1A of the present disclosure shown in FIG. 1 includes a main body 12, and a nozzle 11, which is attached to the main body 12, sprays the liquid 3 in the continuous flow 3a, and turns the continuous flow 3a into droplets 3b. The cleaning apparatus 1A of the present embodiment includes a liquid tank 23 that accumulates the liquid 3 to be sprayed from the nozzle 11, a liquid flow path 13 that partially passes through the inside of the main body 12 and connects the liquid tank 23 and the nozzle 11, and a pump 21 that supplies the liquid 3 from the liquid tank 23 to the nozzle 11.

Here, the pump 21 is provided with a switch 21A for turning the pump 21 on or off. The switch 21A can be turned on or off manually by a user. The cleaning apparatus 1A of the present embodiment includes an spray pressure adjustment section 22 that adjusts a spray pressure of the liquid 3 from the nozzle 11, and a control section 24 that is connected to the spray pressure adjustment section 22 and controls the drive of the pump 21. Examples of the control section 24 include a CPU, an ASIC, and an FPGA. The control section 24 is provided with a memory section 25 that stores various data, a driving program of the pump 21, and the like. As an example of the memory section 25, a volatile memory such as a DRAM or a non-volatile memory such as a ROM or a flash memory can be given.

As described above, the cleaning apparatus 1A of the present embodiment is configured such that the spray of the liquid 3 can be turned on or off by the switch 21A. However, the present disclosure is not limited to such a configuration, and for example, the strength of a spray pressure of the liquid 3 may be controlled by the switch 21A. The switch 21A may be a foot switch that can be operated by a user with his/her feet, or may be a hand switch or the like that is formed on the main body 12 so as to be operable by a user's hand while holding the main body 12. On the other hand, the strength of a spray pressure of the liquid 3 may be changed in accordance with the adhering substance 4b. In the cleaning apparatus 1A of the present embodiment, since the pump 21 can be turned on or off at an appropriate timing by the switch 21A, the usage amount of the liquid 3 can be appropriately controlled, and the removal performance of the adhering substance 4b per usage amount of the liquid 3 can be improved.

With such a configuration, the cleaning apparatus 1A of the present embodiment can remove support material, which is the adhering substance 4b, from a three dimensional molded object, which is the object 4a, in the cleaning target 4 by spraying the liquid 3 from the nozzle 11 to the cleaning target 4 that was molded by a three dimensional molding device that molds a three dimensional molded objects while supporting the three dimensional molded objects with the support material and by causing the liquid 3 to collide with the cleaning target 4 in droplet form. As described above, by causing the liquid 3 to collide with the cleaning target 4 in the droplet 3b form by using the nozzle 11 that sprays the liquid 3 from the nozzle 11 in the continuous flow 3a and changes the continuous flow 3a into droplets 3b, the cleaning effect of the cleaning target 4 by the liquid 3 is dramatically improved as compared with a configuration in which the liquid 3 simply collides with the cleaning target 4 in a continuous flow due to stagnation pressure by spraying water-jet-water from the nozzle 11. Therefore, the cleaning apparatus 1A of the present embodiment can remove the support material from the three dimensional molded object while suppressing damage to the three dimensional molded object when removing the support material from the three dimensional molded object. For example, it is also possible to remove the support material from the three dimensional molded object in a short time compared to a case where a user manually removes the support material from the three dimensional molded object using a tool or the like.

Here, in the cleaning apparatus 1A of the present embodiment, the liquid 3 accumulates in the liquid tank 23 connected to the pump 21. However, the present disclosure is not limited to such a configuration. For example, with respect to the supply of the liquid 3 to the pump 21, tap water as the liquid 3 may be directly supplied to the pump 21 from a tap water faucet by connecting a tube to the tap water faucet. Further, instead of connecting the liquid flow path 13 to the pump 21, the liquid flow path 13 may be directly connected to a tap water faucet. The type of the liquid 3 is not particularly limited. Water such as tap water may be used, or the liquid 3 mixed with polishing powder may be used. When polishing powder is mixed, it is desirable to use the polishing powder having a particle diameter smaller than the inner diameter of the nozzle 11. This is for suppressing the clogging of the nozzle 11 with the polishing powder. Further, it may be the liquid 3 in which a chemical is mixed. Examples of the chemicals that can be mixed include acetone, isopropyl alcohol, and sodium hydroxide.

The cleaning apparatus 1A of the present embodiment includes a configuration capable of removing the support material adhered to the three dimensional molded object molded by the three dimensional molding device including various configurations. In other words, a plurality of types of support materials can be used for the cleaning apparatus 1A of the present embodiment. As described above, the cleaning apparatus 1A of the present embodiment includes the memory section 25 and a spray pressure adjustment section 22. The correspondence relationship between the type of support material and spray pressure of the liquid 3 is stored in the memory section 25, and the spray pressure adjustment section 22 can adjust spray pressure of the liquid 3 from the nozzle 11 in accordance with the type of support material by the control of the control section 24 based on the correspondence relationship. Therefore, the cleaning apparatus 1A of the present embodiment can automatically and suitably adjust spray pressure of the liquid 3 from the nozzle 11 in accordance with the type of the support material, and can effectively remove the support material from the three dimensional molded object. The correspondence relationship is set to a spray pressure at which the support material can be removed and the three dimensional molded object is not damaged.

In the cleaning apparatus 1A of the present embodiment, the nozzle 11 mounted on the main body 12 can be replaced. By replacing the nozzle 11, the nozzle diameter of the spray port through which the liquid 3 is sprayed from the nozzle 11 can be changed. Therefore, the cleaning apparatus 1A of the present embodiment can spray the liquid 3 from the nozzle 11 having a desirable nozzle diameter in accordance with, for example, the type of the support material. In the present embodiment, the liquid 3 can be sprayed from the nozzle 11 having a desirable nozzle diameter in accordance with, for example, the type of the support material by replacing the nozzle 11 mounted on the main body 12. However, without being limited to such a configuration, the nozzle 11 including a plurality of spray ports having different nozzle diameters may be mounted on the main body 12, and the spray port used in the nozzle 11 may be changed as appropriate.

As described above, the cleaning apparatus 1A of the present embodiment can change spray pressure, nozzle diameter, and the like, which are the removal conditions, in accordance with the conditions of the adhering substance 4b to be removed. Further, the cleaning apparatus 1A of the present embodiment includes a temperature adjustment mechanism (heater) (not shown), and can adjust the temperature of the liquid 3 sprayed from the nozzle 11. Therefore, it is possible to adopt a configuration in which a spray pressure of the liquid 3, the nozzle diameter, the type of the liquid 3, the temperature of the liquid 3 based on a temperature adjustment mechanism (not shown), and the like are presented to a user or settings are automatically changed in accordance with conditions such as the material, thickness, density, shape, and the like of the three dimensional molded object and the support material.

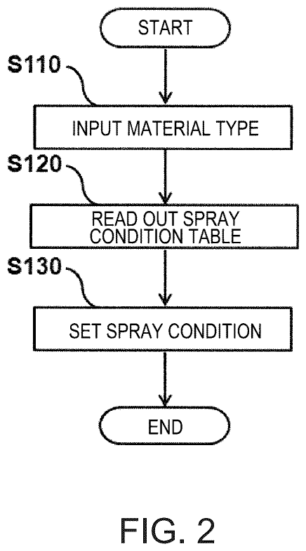

Here, the cleaning apparatus 1A of the present embodiment can automatically change the spray conditions of the liquid 3 from the nozzle 11 by referring to a spray condition table, which is the correspondence relationship stored in the memory section 25, by the input of the material type of the support material from a user, and can present desirable spray conditions on a display section (not shown) or the like. An example thereof will be described below with reference to a flowchart of FIG. 2. As shown in FIG. 2, first, in step S110, a user inputs the material type of the support material via an input section (not shown). Next, in step S120, the cleaning apparatus 1A of the present embodiment reads out a spray condition table, which is the correspondence relationship stored in the memory section 25. Then, finally, in step S120, the cleaning apparatus 1A of the present embodiment sets a spray condition automatically selected in accordance with the material type of the support material to be used or the spray condition selected by a user via the input section (not shown).

As shown in FIG. 1, the cleaning apparatus 1A of the present embodiment includes a reservoir 31, which is a tray capable of storing the liquid 3 that was sprayed from the nozzle 11. Therefore, the cleaning apparatus 1A of the present embodiment can efficiently collect the liquid 3 that was sprayed from the nozzle 11 and the removed support material. Further, it is possible to shorten a cleaning time due to scattering of the liquid 3 or the removed support material to the periphery.

As shown in FIG. 1, the cleaning apparatus 1A of the present embodiment is provided with a hand piece type main body 12 for manual work. Therefore, it is possible to fix the cleaning target 4 and change an arrangement and a posture of the nozzle 11 with respect to the fixed cleaning target 4. However, the cleaning apparatus 1A of the present embodiment is not limited to such a configuration, and may include a configuration in which an arrangement or a posture of the cleaning target 4 is changed with respect to the fixed nozzle 11, or may be configured such that a component such as the nozzle 11 can be replaced or a component can be added in accordance with the type or the like of the cleaning target 4. The cleaning apparatus 1A of the present embodiment may be able to change the spray state of the liquid 3 by using the switch 21A or the like as components are replaced or added. The cleaning apparatus 1A of the present embodiment can use the nozzle 11 including a spray port of one hole, and can also use the nozzle 11 including a spray port of a plurality of holes. By using the nozzle 11 including a spray port of a plurality of holes, the droplets 3b can efficiently collide with a wide surface of the cleaning target 4.

In other words, the cleaning apparatus 1A of the present embodiment includes the main body 12 to which the nozzle 11 is connected, and the liquid flow path 13 as a flow path through which the liquid 3 flows passes through the inside of the main body 12. That is, the cleaning apparatus 1A of the present embodiment includes the main body 12 to which the nozzle 11 is connected and which includes a flow path through which the liquid 3 flows inside. Since the cleaning apparatus 1A of the present embodiment includes such a configuration, a user can grip the main body 12 and easily cause the droplets 3b to collide with a desired location of the cleaning target 4.

### Second Embodiment

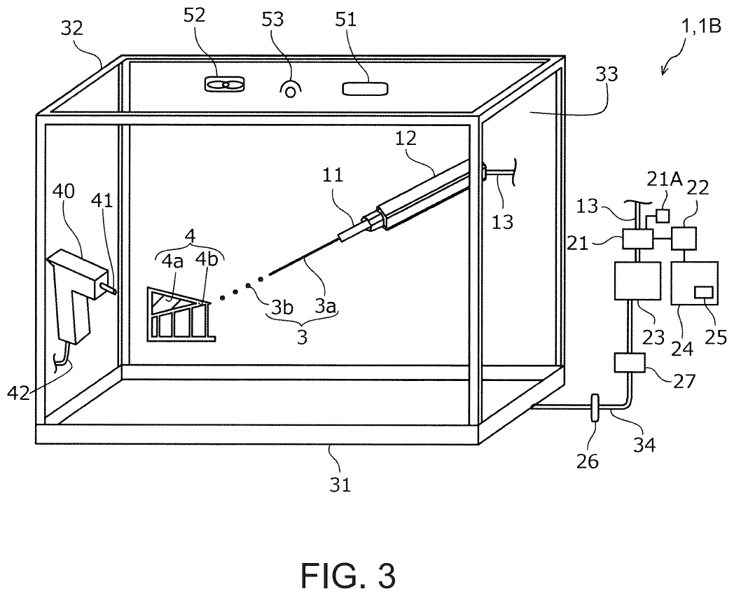

A cleaning apparatus 1B according to a second embodiment will be described below with reference to FIG. 3. FIG. 3 is a diagram corresponding to FIG. 1 of the cleaning apparatus 1A of the first embodiment. The cleaning apparatus 1B of the present embodiment is the same as the cleaning apparatus 1A of the first embodiment except for the configuration described below. Therefore, the cleaning apparatus 1B of the present embodiment has the same features as the cleaning apparatus 1A of the first embodiment except for the following description. In FIG. 3, constituent members common to those of the first embodiment are denoted by the same reference symbols, and a detailed description thereof will be omitted.

As shown in FIG. 3, the cleaning apparatus 1B of the present embodiment includes a housing 32 in which the nozzle 11 is used. The housing 32 is surrounded by a wall section 33, and serves as a glove box into which a user can insert his/her hand from the outside through a hole (not shown) formed in the wall section 33. Therefore, the cleaning apparatus 1B of the present embodiment can suppress the liquid 3 and the removed support material from being scattered to the outside of the cleaning apparatus 1B. Further, by suppressing scattering of the liquid 3 and the support material to the surroundings by the housing 32 and improving a user's field of view at the time of these scattering, it becomes possible to hit the droplets 3b to an appropriate point and it is possible to improve the work efficiency.

As shown in FIG. 3, the housing 32 of the cleaning apparatus 1B of the present embodiment includes the reservoir 31 that accumulates the liquid 3 that was sprayed from the nozzle 11. Therefore, the cleaning apparatus 1B of the present embodiment can efficiently collect the liquid 3 that was sprayed from the nozzle 11. In the present embodiment, the reservoir 31 is configured integrally with the housing 32, but is not limited to such a configuration, and the reservoir 31 and the housing 32 may be configured separately.

As shown in FIG. 3, the cleaning apparatus 1B of the present embodiment includes a circulation mechanism including a circulation tube 34 connected to the reservoir 31 and the liquid tank 23, a pump 27, and a filter 26. The pump 27 is configured to be capable of sending the liquid 3 accumulated in the reservoir 31 to the liquid tank 23 via the circulation tube 34. In other words, the cleaning apparatus 1B of the present embodiment includes a circulation mechanism (circulation tube 34) for spraying the liquid 3 accumulated in the reservoir 31 from the nozzle 11 again. Therefore, the cleaning apparatus 1B of the present embodiment can reuse the liquid 3 that has been once sprayed from the nozzle 11 and collected. By being able to reuse the liquid 3 that has been sprayed and collected, it is possible to reduce the amount of the liquid 3 used.

In the cleaning apparatus 1B of the present embodiment, the reservoir 31 is a tray-like receiving member capable of receiving the liquid 3. However, the receiving member is not limited to such a configuration, and may be, for example, a tank-like shape, or may be a water-absorbing member that can be discarded after use or reused after drying. The cleaning apparatus 1B of the present embodiment is provided with the filter 26 as a countermeasure against mixing of the support material as the adhering substance 4b into the liquid flow path 13. In the cleaning apparatus 1B of the present embodiment, the circulation tube 34 is connected to the reservoir 31 and the liquid tank 23, but the configuration is not limited to this, for example, a tank for collection may be provided, and the liquid 3 may be collected after the support material included in the sprayed liquid 3 is filtered by the filter 26. Further, instead of a tank for collection, a configuration in which the liquid 3 obtained by filtering the support material with the filter 26 can be directly discharged into a drain or the like may be employed.

As shown in FIG. 3, in the cleaning apparatus 1B of the present embodiment, the housing 32 is provided with a temperature adjustment section 51, which is a heater capable of adjusting the temperature inside the housing 32. Therefore, the cleaning apparatus 1B of the present embodiment can improve the performance to remove the support material from the three dimensional molded object by, for example, increasing the temperature in the housing 32.

In the cleaning apparatus 1B of the present embodiment, the housing 32 includes the temperature adjustment section 51, and the temperature adjustment section 51 also serves as a heater that heats the liquid 3 sprayed from the nozzle 11 as a result of adjusting the temperature in the housing 32. By providing a heater for heating the liquid 3 as in the cleaning apparatus 1B of the present embodiment, the performance to remove the support material from the three dimensional molded object can be improved. The temperature adjustment section 51 is not limited to being provided in the housing 32, and may be provided adjacent to the liquid flow path 13, or may be provided in the liquid tank 23 or the like. That is, the temperature adjustment section 51 may have a function of heating the liquid 3 in the liquid tank 23, the pump 21, the pump 27, the liquid flow path 13, the circulation tube 34, or the main body 12, or a function of cooling the liquid 3 in some cases.

Here, the cleaning apparatus 1B of the present embodiment can also be used for a plurality of types as support materials, similar to the cleaning apparatus 1A of the first embodiment. The control section 24 can control the temperature adjustment section 51 as a heater in accordance with the type of the support material to be used as the temperature controller. Therefore, in the cleaning apparatus 1B of the present embodiment, since the support material is easily removed by adjusting the temperature in the housing 32 in accordance with the type of the support material, it is possible to improve the performance of removing the support material from the three dimensional molded object.

As shown in FIG. 3, the cleaning apparatus 1B of the present embodiment is provided with a blower machine 40 capable of causing gas to flow through a gas flow path 42 and blowing the gas into the housing 32 from a blower nozzle 41. By blowing gas, the blower machine 40 can blow away the support material remaining on the cleaning target 4, the liquid 3 deposited to the inside of the housing 32, the support material peeled off from the cleaning target 4, and the like. Further, since a liquid film on a surface where the droplets 3b collide, which is a cause of hindering impact pressure, can be blown off, a state in which the liquid film hinders propagation of the impact pressure can be eliminated, and the performance of removing the support material by the droplets 3b can be improved. Therefore, it is possible to improve the performance of removing the support material from the three dimensional molded object by blowing air from the blower machine 40.

In other words, the cleaning apparatus 1B of the present embodiment includes the housing 32 as a holder for holding an apparatus that is for removing the support material and that is an apparatus different from the nozzle 11. Therefore, the cleaning apparatus 1B of the present embodiment can use an apparatus different from the nozzle 11 for removing the support material, so that the performance to remove the support material from the three dimensional molded object can be improved, and the needs to separately prepare a constituent member for holding the apparatus can be eliminated. As an apparatus different from the nozzle 11 for removing the support material, for example, an air duster such as the blower machine 40, a gas suction device, a vibration device, or the like can be given. When compressed air is used as the power of the pump 21 or the pump 27, exhaust gas from the pump 21 or the pump 27 may be reused as a compressed air source.

As shown in FIG. 3, in the cleaning apparatus 1B of the present embodiment, the housing 32 is provided with a fan 52 for generating an airflow from the inside of the housing 32 toward the outside. Therefore, the cleaning apparatus 1B of the present embodiment can discharge mist of the liquid 3 generated inside the housing 32 to the outside of the housing 32. The cleaning apparatus 1B of the present embodiment includes the fan 52 for sucking out mist, but may include, for example, a charging member for guiding out mist instead of the fan 52.

As shown in FIG. 3, in the cleaning apparatus 1B of the present embodiment, the housing 32 is provided with a black light 53. Therefore, in the cleaning apparatus 1B of the present embodiment, it is easy to visualize the support material remaining on the cleaning target 4.

As described above, the cleaning apparatus 1B of the present embodiment includes various additional members with respect to the cleaning apparatus 1A of the first embodiment, and thus has a configuration in which an appropriate support material removing force can be applied to the cleaning target 4. Specifically, for example, the support material removal performance of the liquid 3 itself is improved by heating the liquid 3 by the temperature adjustment section 51. By blowing air from the blower machine 40 to remove a liquid film that hinders impact pressure, the removal performance when the droplets 3b collide is improved.

As an additional member, a cover capable of sucking out the liquid 3 may be provided on the nozzle 11 or the main body 12 to cover a liquid film or foreign matter with the cover so as to be able to remove them. As an additional member, a holder for holding the additional member may be provided on the nozzle 11 or the main body 12 so that a brush, a scraper, a file, or the like as the additional member can be held. Further, these additional members may be selectively used for spraying droplets 3b in accordance with the type of the support material, the shape of the three dimensional molded object, and the like.

### Third Embodiment

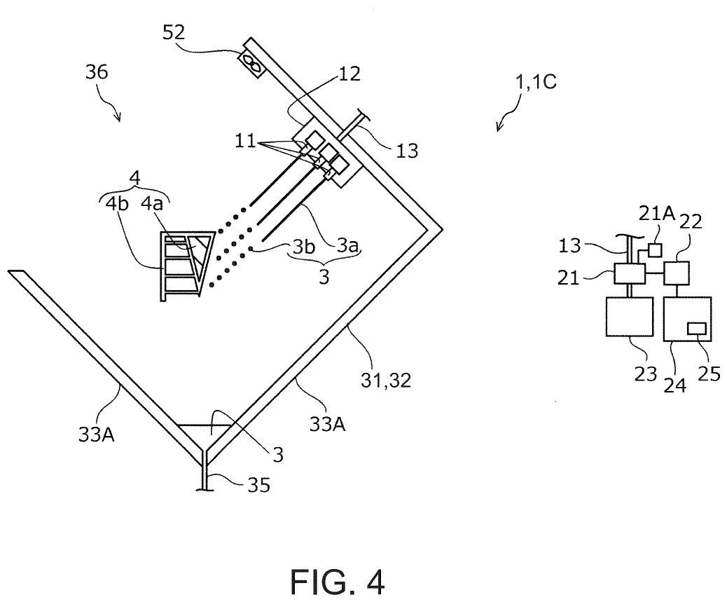

A cleaning apparatus 1C according to a third embodiment will be described below with reference to FIG. 4. FIG. 4 is a diagram corresponding to FIG. 1 of the cleaning apparatus 1A of the first embodiment. The cleaning apparatus 1C of the present embodiment is the same as the cleaning apparatus 1 of the first and second embodiments except for the configuration described below. Therefore, the cleaning apparatus 1C of the present embodiment has the same features as the cleaning apparatus 1 of the first and second embodiments except for the following description. In FIG. 4, constituent members common to those of the first and second embodiments are denoted by the same reference symbols, and a detailed description thereof will be omitted.

As shown in FIG. 4, in the cleaning apparatus 1C of the present embodiment, the main body 12 including a plurality of nozzles 11 is fixed to the housing 32. That is, the cleaning apparatus 1C of the present embodiment is configured to remove the support material adhered to the three dimensional molded object by spraying the liquid 3 from the fixed nozzle 11 and moving the cleaning target 4. In the cleaning apparatus 1C of the present embodiment, the main body 12 includes a plurality of nozzles 11, but is not limited to such a configuration.

As shown in FIG. 4, the cleaning apparatus 1C of the present embodiment includes, in the housing 32, an inclining wall 33A inclined with respect to the horizontal direction, and is configured so that the liquid 3 clinging to the inclining wall 33A flows to a lower section of the housing 32 under the force of gravity. A discharge port 35 connected to a discharge channel is provided at the lower section of the housing 32.

As shown in FIG. 4, the housing 32 of the cleaning apparatus 1C of the present embodiment is substantially C-shaped in cross section, and an opening section 36 is provided. Therefore, the fan 52 is provided in the vicinity of the opening section 36 in the housing 32 for air curtain formation in order to hinder scattering of the removed support material or mist of the liquid 3 to outside of the housing 32.

### Fourth Embodiment

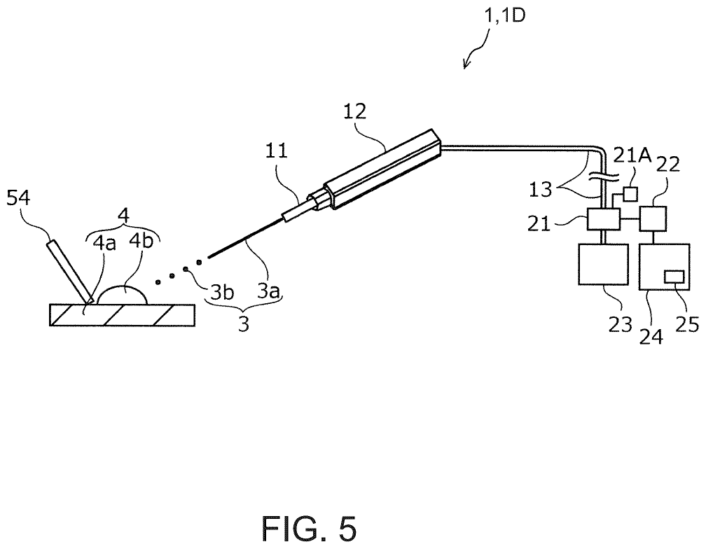

A cleaning apparatus 1D according to a fourth embodiment will be described below with reference to FIGS. 5 to 7. FIGS. 5 to 7 are diagrams corresponding to FIG. 1 of the cleaning apparatus 1A of the first embodiment. The cleaning apparatus 1D of the present embodiment is the same as the cleaning apparatus 1A of the first embodiment except for the configuration described below. Therefore, the cleaning apparatus 1D of the present embodiment has the same features as the cleaning apparatus 1A of the first embodiment except for the following description. In FIGS. 5 to 7, constituent members common to those of the first embodiment are denoted by the same reference symbols, and a detailed description thereof will be omitted.

As shown in FIGS. 5 to 7, the cleaning apparatus 1D of the present embodiment includes substantially the same configuration as the cleaning apparatus 1A of the first embodiment, except that the reservoir 31 is not provided. As the cleaning target 4, a cleaning target other than the object molded by the three dimensional molding device can be used. Therefore, the cleaning apparatus 1D of the present embodiment can be expressed as the cleaning apparatus 1 that includes the nozzle 11 configured to spray the liquid 3 in the continuous flow 3a and change the continuous flow 3a into droplets and the pump 21 configured to supply the liquid 3 to the nozzle 11, and that removes the adhering substance 4b from the cleaning target 4 by spraying the liquid 3 from the nozzle 11 to the cleaning target 4 and causing the liquid 3 to collide with the cleaning target 4 in droplet 3b form. Since the cleaning apparatus 1D of the present embodiment includes such a configuration, it is possible to effectively remove the adhering substance 4b from the cleaning target 4 while suppressing damage to the cleaning target 4 when removing the adhering substance 4b from the cleaning target 4.

A more detailed description will be given below with reference to FIGS. 5 to 7. The cleaning apparatus 1D of the present embodiment is the cleaning apparatus 1 capable of removing printing or paint from a resin surface, removing paint or an adhering substance from a road, a concrete structure, or a metal surface, and at that time is capable of suppressing damage to the underlying base as the object 4a.

FIG. 5 shows a state in which, by using the cleaning apparatus 1D of the present embodiment, only UV ink or toner from sublimation printing is removed without damaging a resin plate as the cleaning target 4 in which the UV ink or the toner by sublimation printing as the adhering substance 4b adheres to the resin plate as the object 4a. In FIG. 5, since a resin plate is arranged horizontally, a scattering prevention plate 54 is arranged in the vicinity of the adhering substance 4b so that the liquid 3 that was sprayed from the nozzle 11 does not scatter.

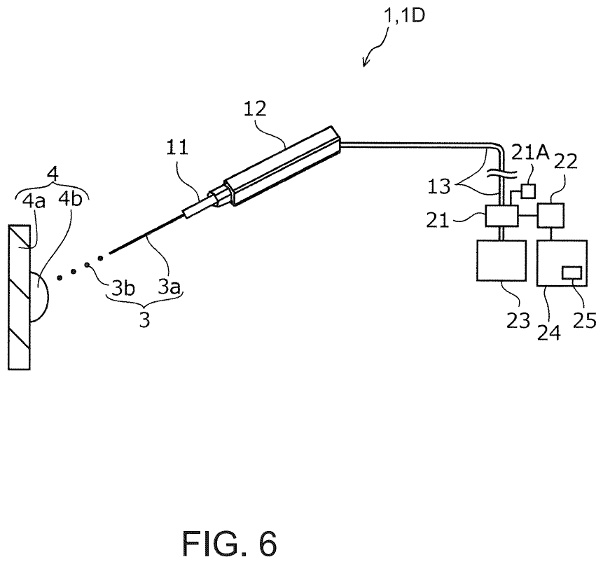

FIG. 6 shows a state in which, by using the cleaning apparatus 1D of the present embodiment, only foreign matter is removed from the cleaning target 4, in which foreign matter such as dirt, rust, mold, ice and the like as the adhering substance 4b is adhered to a wall, a window, a vehicle and the like as the object 4a, without damaging the wall, the window, the vehicle and the like. The liquid 3 that was sprayed from the nozzle 11 and foreign matter peeled off from a wall, a window, a vehicle and the like falls downward under the force of gravity.

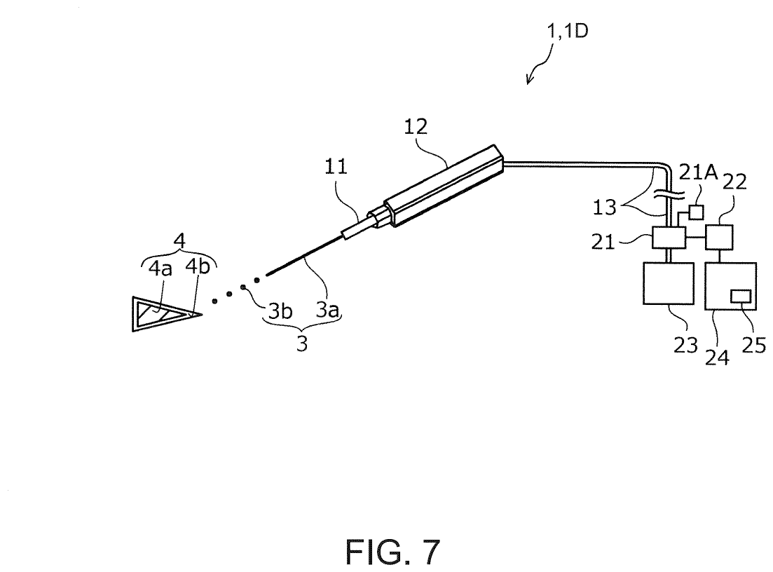

FIG. 7 shows a state in which, by using the cleaning apparatus 1D of the present embodiment, only an adhering substance after processing is removed, without damaging the formed object, from the cleaning target 4 to which the adhering substance after processing such as coolant, dust, processing oil, or chips as the adhering substance 4b adheres to the formed object, which was formed by using a machining device, as the object 4a. The liquid 3 that was sprayed from the nozzle 11 and an adhering substance that was peeled off from the formed object after processing falls downward under the force of gravity.

The present disclosure is not limited to the above-described embodiments, and can be realized by various configurations without departing from the scope of the disclosure. The technical features in the embodiments corresponding to the technical features in each aspect described in the schematic description of the disclosure can be appropriately replaced or combined in order to solve a part or all of the problems described above or in order to achieve a part or all of the effects described above. Unless the technical features are described as essential in the present specification, the technical features can be appropriately deleted. For example, as described above, in the present disclosure, in addition to the nozzle 11 and the main body 12, the pump 21, the control section 24, the reservoir 31, the housing 32, and the like can be included and regarded as the cleaning apparatus 1, but only the nozzle 11 and the main body 12 can be regarded as the cleaning apparatus 1.

What is claimed is:

1. A cleaning apparatus comprising:
a nozzle configured to spray liquid in a continuous flow and change the continuous flow into droplets and
a pump configured to supply the liquid to the nozzle, wherein
the cleaning apparatus is configured to remove a support material from a three dimensional molded object in a cleaning target by causing the liquid from the nozzle to collide with the cleaning target in a droplet form.

2. The cleaning apparatus according to claim 1, further comprising:
a spray pressure adjustment section configured to adjust a spray pressure of the liquid from the nozzle in accordance with a type of the support material.

3. The cleaning apparatus according to claim 2,
further comprising a memory section configured to store a correspondence relationship between type of support material and spray pressure of the liquid.

4. The cleaning apparatus according to claim 1, wherein
the nozzle is configured to change a nozzle diameter.

5. The cleaning apparatus according to claim 1, further comprising:
a heater configured to heat the liquid.

6. The cleaning apparatus according to claim 5, further comprising:
a temperature controller configured to control the heater in accordance with a type of the support material.

7. The cleaning apparatus according to claim 1, further comprising:
a main body to which the nozzle is connected and which includes a flow path through which the liquid flows inside.

8. The cleaning apparatus according to claim 1, further comprising:
a holder configured to hold an apparatus different from the nozzle for removing the support material.

9. The cleaning apparatus according to claim 1, further comprising:
a housing inside which the nozzle is used.

10. The cleaning apparatus according to claim 9, wherein
the housing includes a reservoir that accumulates the liquid that was sprayed from the nozzle.

11. The cleaning apparatus according to claim 10, further comprising:
a circulation mechanism for spraying the liquid accumulated in the reservoir from the nozzle again.

12. The cleaning apparatus according to claim 9, wherein
the housing includes a temperature adjustment section configured to adjust a temperature in the housing.

13. A cleaning apparatus comprising:
a nozzle configured to spray liquid in a continuous flow and change the continuous flow into droplets and
a pump configured to supply the liquid to the nozzle, wherein
the cleaning apparatus is configured to remove an adhering substance from a cleaning target by spraying the liquid from the nozzle to the cleaning target and causing the liquid to collide with the cleaning target in a droplet form.
